(19) United States
(12) Patent Application Publication
(10) Pub. No.: US 2017/0204336 A1
(43) Pub. Date: Jul. 20, 2017

(54) QUENCHING VACUUM DISTILLATION COLUMN WASH ZONE LIQUID

(71) Applicant: Fluor Technologies Corporation, Sugar Land, TX (US)

(72) Inventor: Hemant Bhatia, Foothill Ranch, CA (US)

(21) Appl. No.: 14/995,656

(22) Filed: Jan. 14, 2016

(51) Int. Cl. C10G 7/00; B01D 3/10; B01D 3/34; B01D 3/06; B01D 3/00

(52) U.S. Cl. CPC C10G 7/00; B01D 3/06; B01D 3/008; B01D 3/34; B01D 3/10

(57) ABSTRACT

A crude separation unit comprises a feed heater, a distillation column comprising a wash zone and a flash zone, a wash zone outlet line fluidly coupled to the distillation column in the wash zone, and a wash oil circulation loop. The feed heater comprises a feed line and a heater outlet line, and the heater outlet line is fluidly coupled to the distillation column in the flash zone. The wash oil circulation loop comprises a fluid conduit disposed in a loop, a pump disposed in the loop, a heat exchanger disposed in the loop, and a recycle line fluidly coupling the fluid conduit and the feed line. The wash zone outlet is fluidly coupled to the fluid conduit.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A petroleum stream can be separated into various liquid and/or vapor hydrocarbon streams comprising different components of the original stream. As crude oil is processed, it is generally separated into different component streams based on different boiling point range fractions. These distillate fractions are then sent for further downstream processing. Various types of distillation columns and separators can be used in the processing of the crude oil, with tradeoffs between quality and yield being associated with each type and overall configuration of the units. When lighter distillate fractions are desired, the configuration of the separation units can be modified to increase both the quality and yield of these streams.

### SUMMARY

In an embodiment, a crude separation unit comprises a feed heater, a vacuum distillation column comprising a wash zone and a flash or flash zone, a wash zone outlet line fluidly coupled to the distillation column in the wash zone, and a wash oil circulation loop. The feed heater comprises a feed line and a heater outlet line, and the heater outlet line is fluidly coupled to the distillation column in the flash zone. The wash oil circulation loop comprises a fluid conduit disposed in a loop, a pump disposed in the loop, a heat exchanger disposed in the loop, and a recycle line fluidly coupling the fluid conduit and the feed line. The wash zone outlet is fluidly coupled to the fluid conduit.

In an embodiment, a method for separating a crude oil stream comprises feeding a feed stream into a flash zone of a distillation column, washing a vapor from the flash zone in a wash zone using wash oil, collecting and removing the wash oil from the distillation column, quenching the wash oil to produce a quenched wash oil stream, and recycling at least a portion of the quenched wash oil to an inlet of a feed heater. The feed heater heats the quenched wash oil and a crude feed stream prior to feeding the feed stream into the flash zone of the distillation column.

In an embodiment, a method of quenching a wash oil stream comprises drawing a wash oil stream from a wash oil collection tray in a vacuum distillation unit, passing the wash oil into a wash oil tank, mixing the wash oil with cooler wash oil in the wash oil tank to form a circulating wash oil, cooling the circulating wash oil, and circulating the circulating wash oil back to the wash oil tank after cooling the circulating wash oil.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a process flow diagram of a vacuum distillation system comprising a quenching system according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Disclosed herein is a distillation process comprising a vacuum distillation unit for processing hydrocarbons such as crude oil that can have a quenching system for quenching the wash zone liquids. The distillation unit can comprise a wash zone that is used to limit the amount of entrained liquids passing upwards in the column from a flash zone into which the feed is introduced into the column. In general, wash oil is introduced above a wash bed, where the liquid wash oil passes through a packed bed comprising packing, contacts any entrained liquid particles in the vapor passing upwards, and condenses any high boiling components. Rather than allowing the wash oil to pass to the residue stream passing out of the bottom of the column, the wash oil can be taken out of the distillation column and quenched prior to passing through a pump. The quenching step may cool the wash oil to a temperature at which the formation of coke or other byproducts is limited or prevented. For example, coke formation can occur above about 700° F., and quenching the streams to below about 660° F. should reduce the amount of coke formed (e.g., keep the amount of coke formed below about 400 parts per million by weight (ppmw)). The quenching may then prevent the pump from fouling, which may improve the operating life and onstream time of the pump and the associated equipment. Ultimately, the quenched wash oil can be recycled to the inlet to a feed beater to be combined with the feed to the distillation column. The recoverable fractions in the wash oil can then be recovered in the distillation column, which can help improve the quality and yield of the product fractions in the distillation process.

The quenching of the wash oil can be provided in a number of ways. In an embodiment, the wash oil can be drawn from the wash oil collection tray and passed into a circulating loop having cooled wash oil. The cooled wash oil can have a sufficient flowrate to cool the wash oil being drawn from the distillation column. In some embodiments, the wash oil drawn from the wash oil collection tray can pass into a wash oil tank to cool the wash oil. The wash oil from the wash oil tank can then be circulated in a wash oil circulation loop. As part of the wash oil circulation loop, the circulating wash oil can pass through a heat exchanger to cool the circulating wash oil. Once cooled, the wash oil can be circulated back to the wash oil tank. A level controller can be used with the wash oil tank to control the flowrate of the circulated wash oil back to the inlet of the feed heater for the distillation unit. A temperature controller can be used to control the circulation rate in the wash zone circulation loop, which can then control the temperature of the circulating wash oil.

In a crude processing unit, a crude oil distillation unit, which can also be referred to as an atmospheric crude fractionating unit or column, can generally be the first processing unit for the crude oil. Reduced crude (e.g., the bottoms product from the atmospheric unit, a heavy oil stream, etc.) from the crude oil distillation unit can then pass to a second distillation unit that typically operates at sub-atmospheric pressure and can be referred to as a vacuum crude distillation or fractionating unit. The vacuum distillation unit can further separate additional distillate streams from the heavy residue fraction that can also contain additional elements such as metals and asphaltenes present in the crude fraction or fractions fed to the vacuum distillation unit. A number of product streams are typically produced from the vacuum distillation unit including a light vacuum gas oil (LVGO), a heavy vacuum gas oil (HVGO), and a residue product stream. An overhead vapor is also typically removed to maintain the sub-atmospheric pressure in the vacuum distillation unit. The LVGO fraction may have a boiling point range between about 500° F. to about 950° F. (about 260° C. to about 510° C.), the HVGO fraction may have a boiling point range between about 650° F. to about 1,200° F. (about 340° C. to about 650° C.), and the residue product can have a boiling point range above that of the HVGO fraction. In some embodiments, the distillation units and processes described herein can be used with a deep cut distillation operation, in which the boiling range of the HVGO fraction may be taken to be between about 1,050° F. to about 1,200° F. (e.g., between about 565° C. to about 650° C.), or between about 1,080° F. to about 1,100° F. (e.g., between about 582° C. to about 593° C.). The products recovered from the vacuum distillation unit can be passed to various downstream processing units for conversion into more valuable products. Any suitable downstream processes can be used including, but not limited to, fluid catalytic cracking, hydrotreating, hydrocracking, further separation or fractionation, coking units (e.g., for the residue product), or the like.

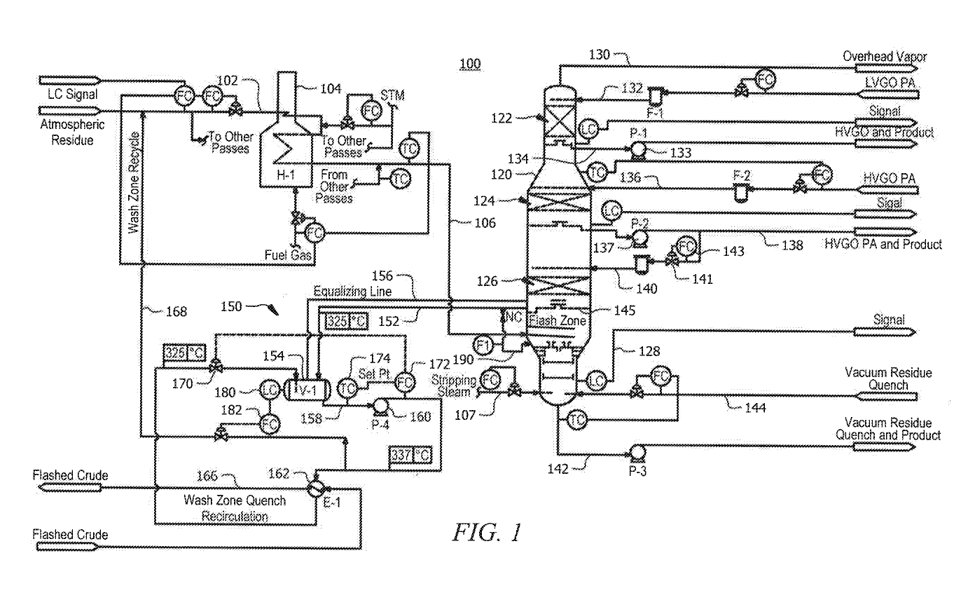

FIG. 1 depicts a process flow diagram of a portion of a vacuum distillation column 120 and accompanying elements that are part of the vacuum distillation system 100. The overall system 100 generally comprises a feed pre-heater 104 configured to heat the feed in line 102 before passing the heated feed in line 106 to the vacuum distillation column 120. The distillation column 120 can be defined by a plurality of zones, which can comprise a first fractionation (and heat transfer) zone 122 including the LVGO draw through line 134, a second fractionation (and heat transfer) zone 124 including the HVGO draw through line 138, a fractionation and wash zone 126, a flash zone or flash zone 128, and a stripping section that generally includes the bottom of the vacuum distillation column 120. The vacuum distillation column 120 also comprises a vapor removal system for maintaining sub-atmospheric pressure in the distillation column. The vapor removal system comprises of a steam ejector system fluidly coupled above a hotwell and at an elevation high enough to maintain a barometric seal against atmospheric pressure.

The feed stream in line 106 generally comprises mostly vapor by weight and almost all vapor by volume as the feed stream enters the vacuum distillation column 120. The two phase flow, when combined with the relatively high feed flow rates and velocities, can result in the feed entering the vacuum distillation column forming a mist so that at least a portion of the liquid in the feed stream is present as droplets in the vapor flow. A portion of the liquid droplets can fall out of the fluid stream by gravimetric separation and pass to the lower portion of the vacuum distillation column 120 to form the residue stream. Stripping steam can be introduced into the bottom section of the distillation column 120 below the stripping section through line 107 to further vaporize any HVGO or LVGO components present in the liquid residue stream in the bottom of the vacuum distillation column 120. The residue product can then be withdrawn from the vacuum distillation column 120 through the residue product line 142. In some embodiments, a residue quench stream can be introduced into the vacuum distillation column 120 through the residue quench line 144 at a point above the residue product draw. The residue quench stream can comprise a portion of recycled and cooled residue product to quench the residue product below a temperature at which coke forms in the residue. This quench stream can serve to limit the amount of coke formed in the residue stream, which can foul a pump in the residue product line 142 and lead to increased maintenance needs as well as unit downtime.

The vapor and a remaining portion of the entrained liquid droplets in the feed can pass upwards from the flash zone 128 into the wash zone 126. In the wash zone 126, the entrained liquid droplets can be removed from the rising vapor by scrubbing the vapor with a wash oil using trays or packing to improve the liquid/vapor contact. The vapor with all or substantially all of the entrained liquid removed can then pass into the upper fractionating and heat transfer sections of the vacuum distillation column 120.

At or near the top of the vacuum distillation column 120 is a first fractionating and heat transfer zone 122. In the first zone 122, the LVGO product can be condensed from the vapor rising through the vacuum distillation column 120. Below the first zone 122 is a draw tray (e.g., a chimney draw tray, etc.) for collecting the condensed LVGO product, which can be drawn from the vacuum distillation column 120 through the LVGO product line 134. A LVGO pump 133 can recirculate at least an externally cooled portion of the collected LVGO product back to the first fractionation zone 122 through the LVGO pump around line 132. The LVGO product passing through the pump-around line 132 can be cooled relative to the LVGO product passing through the LVGO product line 134. Various control elements such as a temperature controller, a flow controller and/or level controller can be used to control a flow rate of the recirculated LVGO product through the LVGO pump around line 132 via one or more control valves. The LVGO pump 133 can also pump at least a portion of the collected LVGO product through the LVGO product line 138 for further processing.

A second fractionation and heat transfer zone 124 can be disposed below the first fractionation zone 122. The second fractionation zone 124 can be used to condense and produce an HVGO product from the vapors rising through the vacuum distillation column 120. Located below the second fractionation zone 124 is a draw tray for collecting the condensed HVGO product. An HVGO pump 137 can pump the HVGO product through HVGO product line 138 for further processing, for example, in a FCC Unit or a Hydrocracking Unit. At least a portion of the HVGO product can be recirculated back to the HVGO section in the second fractionation zone 124 through HVGO pump around line 136. A temperature controller that cascades a set point to a flow controller can be provided for maintaining a heat balance by controlling the flow rate of the recirculated HVGO through the HVGO pump around line 136 via one or more control valves. The pump 137 can also pump at least a portion of the collected HVGO product through the wash oil line 140 for use as wash oil in wash zone 126, as described in more detail herein. While not shown in the interest of clarity, various additional components such as filters, pumps, safety equipment, and the like can also be included in the first fractionation zone 122, the second fractionation zone 124, or any other portion of the vacuum distillation column 120. Any vapor that is not condensed in the uppermost fractionation zone can pass out of the vacuum distillation column 120 as an overhead vapor stream passing through line 130, which may be connected to a vacuum system.

In an embodiment, the wash oil used in the wash zone 126 is a portion of the heaviest distillate product obtained by condensation in a fractionation zone located just above the wash zone, which in the embodiment illustrated in FIG. 1 is the second fractionation zone producing the HVGO product. The wash oil can be used in the wash zone 126 to remove entrained liquid droplets from the vapor rising through the wash zone 126. A valve such as control valve 141 can be used to control the flow rate of the wash oil in response to a signal communicated by a flow controller 143. The wash oil can pass to one or more liquid distributors provided at a top portion of packing or one or more trays in the wash zone 126. As vapor in the fluid feed stream rises upwards in the vacuum distillation column 120 through the packing or trays, the vapor can be scrubbed by contact with the wash oil to remove at least a portion of the liquid entrained in the vapor.

A collection tray 145 such as a chimney tray can be positioned at the bottom of the wash zone 126 to collect the liquid falling from the packing or trays. In some systems, the wash oil can be allowed to flow down into the flash zone to form a portion of the residue, which would result in any product contained in the wash oil (e.g., the HVGO product) being lost to the residue product stream, which is typically of lower value than the HVGO product stream. In some embodiments, the wash oil collected on the collection tray 145 can be recycled back to an entrance of the feed heater 104 to further recover products contained in the wash oil. The collected wash oil can be at or above a temperature at which coke or other carbonaceous materials can form in the wash oil. Simply passing the wash oil through a recycle pump may result in fouling of the wash oil recycle pump and recycle line. In order to reduce the risk of fouling of a recycle pump and line when the wash oil is recycled to an entrance of the feed heater 104, a wash oil quenching system 150 can be used to cool the wash oil being drawn from the vacuum distillation column 120 through the wash oil draw line 152 prior to recycling the wash oil to the feed heater 104. In an embodiment, an optional bypass line 190 may be positioned to direct the wash oil from the collection tray 145 to the flash zone 128. Such a bypass line 190 may be useful when the wash oil quenching system 150 is not operational.

The wash oil quenching system 150 can comprise a circulation loop including a fluid conduit disposed in a loop with a pump 160 used to circulate the circulating wash oil. The loop can be in fluid communication with the wash oil collection tray 145 and configured to receive the wash oil from the collection tray 145. The loop can also be in fluid communication with a wash oil recycle line 168 that allows a portion of the wash oil circulating in the circulation loop to be passed back to an entrance of the feed heater 104. The circulating wash oil can be cooled in the circulation loop and used to quench the wash oil received from the wash oil collection tray 145, which may reduce the temperature of the wash oil to below a temperature at which coke or other byproducts may form in any appreciable amounts.

In an embodiment, the circulation loop can comprise a wash oil tank 154 that is coupled to the wash zone collection tray 145 through line 152. A vapor balancing line 156 can be coupled to the wash oil tank 154 and the vacuum distillation column 120 at or near the wash oil collection tray 145 to vapor balance the wash oil tank 154 with the vacuum distillation column 120. The wash oil tank 154 can comprise any suitable vessel configured to retain the wash oil as part of the circulation loop. Various internal control and safety elements such as level sensors, temperature sensors, pressure sensors, and the like can be used with the wash oil tank 154.

The wash oil tank 154 may allow the wash oil from the wash oil collection tray 145 to be quenched in a volume of the circulating and cooler wash oil. In an embodiment, the wash oil from the wash oil collection tray 145 can be at a temperature between about 680° F. to about 715° F. (e.g., between about 360° C. and about 380° C.). The circulating wash oil in the loop that is present in the wash oil tank 154 may be between about 575° F. and about 645° F. (e.g., between about 300° C. and about 340° C.). The relative volume of wash oil in the wash oil tank 154 may be sufficient to quench the entering volume of wash oil to a temperature in the range of between about 575° F. and about 645° F. (e.g., between about 300° C. and about 340° C.) upon contact with the circulating wash oil in the wash oil tank 154. The quenching of the wash oil may reduce or prevent the formation of coke or other byproducts in the wash oil prior to the wash oil passing through the pump 160, which may extend the service life of the pump 160 and reduce operational maintenance and shutdowns.

The circulating wash oil can be circulated by a pump 160 disposed in the circulation loop in line 158. In order to cool the circulating wash oil in the wash oil quenching system 150, a heat exchanger 162 can also be disposed in the circulation loop line 158. The heat exchanger 162 can comprise any suitable heat exchanger configured to cool the circulating wash oil using another process stream such as an entering crude oil stream and/or heat exchange with air. While depicted as a single heat exchanger 162, two or more heat exchangers disposed in series or parallel can be used to achieve a desired outlet temperature for the circulating wash oil, and in some embodiments, providing redundancy for maintenance purposes. In an embodiment, the heat exchanger 162 can be used to exchange heat between the circulating wash oil and a crude oil stream in line 166. The circulating wash oil can pass out of the heat exchanger 162 and pass back to the wash oil tank 154. While the pump 160 is depicted in FIG. 1 as being disposed in the circulation loop between the wash oil tank 154 and the heat exchanger 162, the pump can be disposed at any point in the circulation loop to provide the desired wash oil circulation.

The temperature in the circulation loop can be controlled using a flow controller 172 coupled to a temperature sensor 174. The flow controller can be in signal communication with and control a circulation loop control valve 170. When the temperature in the circulation loop is above a set-point, the flow rate in the circulation loop can be increased to provide additional cooling in the circulation loop. The circulation rate can be controlled as needed to maintain the temperature of the wash oil circulating in the circulation loop.

A recycle line 168 can be coupled to the circulation loop line 158 to allow a portion of the circulating wash oil to pass from the circulation loop back to an entrance to the feed heater 104. The flow rate of the wash oil passing to the feed heater 104 can be controlled based on a level sensor 180 in the wash oil tank 154. The level sensor 180 can be coupled to a flow controller 182 that is in signal communication with a recycle line control valve 184. The flow controller 182 can maintain the level of wash oil in the wash oil tank 154, and thereby the volume of wash oil circulating in the circulation loop by controlling the volume of wash oil being recycled to the feed heater 104. In general, the flow rate of the wash oil passing through the recycle line 168 to the feed heater 104 will approximately match the volume of wash oil being received from the collection tray 145 such that the volume of wash oil circulating in the circulation loop may remain approximately constant during operation.

The wash oil that is recycled back to the feed heater 104 can be combined with a feed stream in line 102 being sent to the feed heater 104. While illustrated as being combined with the feed stream in line 102, the recycled wash oil in recycle line 168 can also pass directly into the feed heater 104 and be combined with the feed stream within or after passing through the feed heater 104. When the feed stream and the recycled wash oil are combined prior to passing into the feed heater 104, the feed heater 104 can heat the combined feed stream to produce a multiphase feed stream as described herein. The resulting heated multiphase feed stream can then be introduced into the vacuum distillation column in the flash zone 128, where any LVGO or HVGO fractions entrained in the wash oil can be recovered in the corresponding product streams.

Since the wash oil is recycled in the embodiment shown in FIG. 1, a greater portion of the HVGO fraction in the feed stream can be recovered in the HVGO product stream as opposed to allowing the wash oil portion to pass out of the vacuum distillation column 120 with the residue product. Further, by quenching the wash oil, the recycle line 168 and pump 160 may have fewer operation issues, including those associated with coke and/or byproduct generation and buildup due to high temperature wash oil passing through a recycle pump.

In an embodiment, the quenching system 150 can be used to quench a wash oil stream generated in a vacuum distillation column 120. Referring to FIG. 1, a quenching process can begin by drawing a wash oil stream from a wash oil collection tray 145 in a vacuum distillation column 120. The wash oil stream can be at a relatively high temperature and can pass to a wash oil tank having cooler circulating wash oil. The wash oil from the collection tray 145 can be mixed with the circulating wash oil to quench the hotter wash oil to a temperature below a coke formation temperature, including any of the temperatures described herein. Once the wash oil from the collection tray 145 is quenched, the wash oil can form a portion of the wash oil circulating in the circulation loop. The circulating wash oil can then continue to circulate to cool additional wash oil from the collection tray 145. In an embodiment, a pump 160 can be used to circulate the circulating wash oil and/or pass at least a portion of the circulating wash oil to a feed heater 104. In an embodiment, the circulating wash oil can be quenched prior to allowing the wash oil from the collection tray 145 to pass through the pump 160.

As the circulating wash oil is circulating in the circulation loop, the wash oil can be circulated through a heat exchanger 162 using the pump 160. The circulating wash oil can then be cooled in the heat exchanger 162 prior to circulating through the circulation loop and back to the wash oil tank 154. The circulating wash oil can indirectly contact a separate stream such as a cooler crude oil stream in the heat exchanger 162.

In order to control the temperature of the circulating wash oil in the circulation loop, including the circulating wash oil in the wash oil tank 154, a control system can be used to control the temperature. The control system can receive a temperature measurement from a temperature sensor 174 and actuate a control valve 170 to regulate the flow rate of the circulating wash oil in the circulation loop.

A portion of the circulating wash oil can be recycled to a feed heater 104. The amount of the circulating wash oil passed to the feed heater 104 can be controlled using a control system, which can be the same control system used to control the temperature in the circulation loop. The control system can comprise a level sensor 180 in the wash oil tank 154 that provides a level signal to the control system. The control system can then actuate and control the position of a recycle line control valve 184, which can be moved towards an opened position to allow more circulating wash oil to pass to the feed heater 104 or moved towards a closed position to allow less circulating wash oil to pass to the feed heater 104.

The quenching system 150 can be used to cool the wash oil stream from a distillation column such as vacuum distillation column 120. In an embodiment, the wash oil can be used in a wash zone positioned above a flash zone in the vacuum distillation column 120. In general, the wash oil can be obtained from the highest boiling component(s) produced above the wash zone 126. For example, the wash oil can comprise a portion of the HVGO product stream that is recycled to the wash zone 126. The wash oil can be passed over packing and/or through one or more trays to allow entrained liquid in the vapor passing upwards through the wash zone to be removed from the vapor. The wash oil passing through the wash zone can then be collected and removed using, for example, the wash oil collection tray 145. The collected wash oil can then be passed to the quenching system 150 to quench the wash oil prior to the wash oil being recycled to the feed heater 104 as described above.

Although embodiments of the invention are discussed primarily in connection with the processing of a feed stream fed to a vacuum distillation column operating at a low pressure, the operating principles and advantages of embodiments of the invention are applicable to any distillation system and process in which it is desirable to quench a wash oil to prevent the formation of coke or other byproducts within the wash oil from a wash zone.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

In order to demonstrate the improvement of the use of the quenching system for the wash oil, a process model is used to model the HVGO yield for a first process having a wash zone quenching system and recycle as described herein, and a second process in which the wash oil is passed from the wash zone to the flash zone for recovery as part of the residue product stream. The model determines that the first process with the wash oil recycle to the feed heater has a HVGO cutpoint of 570° C. and a HVGO yield on reduced crude of 37.0%. The second process in which the wash oil is not recycled has a HVGO cutpoint of 548° C. and a yield on reduced crude of 31.4%. Thus, the use of the wash oil recycle to the feed heater, and the quenching system to allow for improved operation of the wash oil recycle to the feed heater, results in an improvement in the yield on the reduced crude of 5.6%.

Having described numerous devices, systems, and method herein, various embodiments can include, but are not limited to:

In a first embodiment, a crude separation unit comprises a feed heater, wherein the feed heater comprises a feed line and a heater outlet line; a distillation column comprising a wash zone and a flash zone, wherein the heater outlet line is fluidly coupled to the distillation column in the flash zone; a wash zone outlet line fluidly coupled to the distillation column in the wash zone; and a wash oil circulation loop comprising: a fluid conduit disposed in a loop, a pump disposed in the loop, a heat exchanger disposed in the loop, and a recycle line fluidly coupling the fluid conduit and the feed line, wherein the wash zone outlet is fluidly coupled to the fluid conduit.

A second embodiment can include the crude separation unit of the first embodiment, wherein the wash oil circulation loop further comprises a wash oil tank fluid coupled to the loop.

A third embodiment can include the crude separation unit of the second embodiment, further comprising: a control system comprising a level sensor configured to detect a liquid level within the wash oil tank and a flow control valve disposed in the recycle line, wherein the control system is configured to actuate the flow control valve to maintain the liquid level in the wash oil tank at or below a threshold value.

A fourth embodiment can include the crude separation unit of the second or third embodiment, further comprising: a control system comprising a temperature sensor configured to detect a temperature of a wash oil within the loop and a flow control valve disposed in the fluid conduit, wherein the control system is configured to maintain the temperature of the wash oil at or below a threshold value by controlling a flow rate of the wash oil within the loop.

A fifth embodiment can include the crude separation unit of any of the first to fourth embodiments, wherein the heat exchanger is configured to exchange heat between a wash oil fluid in the loop and an external process stream.

In a sixth embodiment, a method for separating a crude oil stream comprises feeding a feed stream into a flash zone of a distillation column; washing a vapor from the flash zone in a wash zone using wash oil; collecting and removing the wash oil from the distillation column; quenching the wash oil to produce a quenched wash oil stream; and recycling at least a portion of the quenched wash oil to an inlet of a feed heater, wherein the feed heater heats the quenched wash oil and a crude feed stream prior to feeding the feed stream into the flash zone of the distillation column.

A seventh embodiment can include the method of the sixth embodiment, wherein the distillation column comprises a vacuum distillation column, and wherein the flash zone is located below the wash zone.

An eighth embodiment can include the method of the sixth or seventh embodiment, wherein quenching the wash oil comprises: passing the wash oil into a wash oil tank; mixing the wash oil with cooler wash oil in the wash oil tank to form a circulating wash oil; circulating the circulating wash oil through a heat exchanger to cool the circulating wash oil; and circulating the circulating wash oil back to the wash oil tank after passing through the heat exchanger.

A ninth embodiment can include the method of the eighth embodiment, wherein the heat exchanger indirectly contacts the circulating wash oil with a separate crude oil stream that is cooler than the circulating wash oil.

A tenth embodiment can include the method of the eighth or ninth embodiment, further comprising: detecting a temperature of the circulating wash oil; and controlling a flow control valve to control the flowrate of the circulating wash oil circulated.

An eleventh embodiment can include the method of any of the eighth to tenth embodiments, further comprising: detecting a liquid level in the wash oil tank; and controlling a flowrate of at least the portion of the quenched wash oil to the inlet of the feed heater to control the level of the liquid in the wash oil tank.

A twelfth embodiment can include the method of any of the sixth to eleventh embodiments, wherein recycling the quenched wash oil comprises passing the quenched wash oil through a pump, and wherein quenching of the wash oil occurs prior to passing the quenched wash oil stream through the pump.

A thirteenth embodiment can include the method of any of the sixth to twelfth embodiments, further comprising: removing a HVGO stream from the distillation column during the distillation, wherein the wash oil comprises a portion of the HVGO stream.

In a fourteenth embodiment, a method of quenching a wash oil stream comprises drawing a wash oil stream from a wash oil collection tray in a vacuum distillation unit; passing the wash oil into a wash oil tank; mixing the wash oil with cooler wash oil in the wash oil tank to form a circulating wash oil; cooling the circulating wash oil; and circulating the circulating wash oil back to the wash oil tank after cooling the circulating wash oil.

A fifteenth embodiment can include the method of the fourteenth embodiment, wherein cooling the circulating wash oil comprises: circulating the circulating wash oil through a heat exchanger to cool the circulating wash oil.

A sixteenth embodiment can include the method of the fifteenth embodiment, wherein the heat exchanger indirectly contacts the circulating wash oil with a separate crude oil stream that is cooler than the circulating wash oil.

A seventeenth embodiment can include the method of any of the fourteenth to sixteenth embodiments, further comprising: detecting a temperature of the circulating wash oil; and controlling a flow control valve to control the flowrate of the circulating wash oil.

An eighteenth embodiment can include the method of any of the fourteenth to seventeenth embodiments, further comprising: recycling at least a portion of the circulating wash oil to an entrance of a feed heater through a pump, wherein the cooling of the circulating wash oil occurs prior to passing the quenched wash oil stream through the pump.

A nineteenth embodiment can include the method of the eighteenth embodiment, further comprising: detecting a liquid level in the wash oil tank; and controlling a flowrate of at least the portion of the circulating wash oil recycled to the inlet of the feed heater to control the level of the liquid in the wash oil tank.

A twentieth embodiment can include the method of any of the fourteenth to nineteenth embodiments, further comprising: removing a HVGO stream from the vacuum distillation unit during a distillation, wherein the wash oil stream comprises a portion of the HVGO stream that is recycled to the vacuum distillation unit during the distillation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A crude separation unit comprising:
a feed heater, wherein the feed heater comprises a feed line and a heater outlet line;
a distillation column comprising a wash zone and a flash zone, wherein the heater outlet line is fluidly coupled to the distillation column in the flash zone;
a wash zone outlet line fluidly coupled to the distillation column in the wash zone; and
a wash oil circulation loop comprising: a fluid conduit disposed in a loop, a pump disposed in the loop, a heat exchanger disposed in the loop, and a recycle line fluidly coupling the fluid conduit and the feed line, wherein the wash zone outlet line is fluidly coupled to the fluid conduit.

2. The crude separation unit of claim 1, wherein the wash oil circulation loop further comprises a wash oil tank fluid coupled to the loop.

3. The crude separation unit of claim 2, further comprising:
a control system comprising a level sensor configured to detect a liquid level within a wash oil tank and a flow control valve disposed in the recycle line, wherein the control system is configured to actuate the flow control valve to maintain the liquid level in the wash oil tank at or below a threshold value.

4. The crude separation unit of claim 2, further comprising:
a control system comprising a temperature sensor configured to detect a temperature of a wash oil within the loop and a flow control valve disposed in the fluid conduit, wherein the control system is configured to maintain the temperature of the wash oil at or below a threshold value by controlling a flow rate of the wash oil within the loop.

5. The crude separation unit of claim 1, wherein the heat exchanger is configured to exchange heat between a wash oil fluid in the loop and an external process stream.

6. A method for separating a crude oil stream comprising:
feeding a feed stream into a flash zone of a distillation column;
washing a vapor from the flash zone in a wash zone using wash oil;
collecting and removing the wash oil from the distillation column;
quenching the wash oil to produce a quenched wash oil stream; and
recycling at least a portion of the quenched wash oil to an inlet of a feed heater, wherein the feed heater heats the quenched wash oil and a crude feed stream prior to feeding the feed stream into the flash zone of the distillation column.

7. The method of claim 6, wherein the distillation column comprises a vacuum distillation column, and wherein the flash zone is located below the wash zone.

8. The method of claim 6, wherein quenching the wash oil comprises:
passing the wash oil into a wash oil tank;
mixing the wash oil with cooler wash oil in the wash oil tank to form a circulating wash oil;
circulating the circulating wash oil through a heat exchanger to cool the circulating wash oil; and
circulating the circulating wash oil back to the wash oil tank after passing through the heat exchanger.

9. The method of claim 8, wherein the heat exchanger indirectly contacts the circulating wash oil with a separate crude oil stream that is cooler than the circulating wash oil.

10. The method of claim 8, further comprising:
detecting a temperature of the circulating wash oil; and
controlling a flow control valve to control a flowrate of the circulating wash oil circulated.

11. The method of claim 8, further comprising:
detecting a liquid level in the wash oil tank; and
controlling a flowrate of at least the portion of the quenched wash oil to the inlet of the feed heater to control the level of the liquid in the wash oil tank.

12. The method of claim 6, wherein recycling the quenched wash oil comprises passing the quenched wash oil through a pump, and wherein quenching of the wash oil occurs prior to passing the quenched wash oil stream through the pump.

13. The method of claim 6, further comprising:
removing a HVGO stream from the distillation column during the distillation, wherein the wash oil comprises a portion of the HVGO stream.

14. A method of quenching a wash oil stream comprising:
drawing a wash oil stream from a wash oil collection tray in a vacuum distillation unit;
passing the wash oil into a wash oil tank;
mixing the wash oil with cooler wash oil in the wash oil tank to form a circulating wash oil;
cooling the circulating wash oil; and
circulating the circulating wash oil back to the wash oil tank after cooling the circulating wash oil.

15. The method of claim 14, wherein cooling the circulating wash oil comprises:
circulating the circulating wash oil through a heat exchanger to cool the circulating wash oil.

16. The method of claim 15, wherein the heat exchanger indirectly contacts the circulating wash oil with a separate crude oil stream that is cooler than the circulating wash oil.

17. The method of claim 14, further comprising:
detecting a temperature of the circulating wash oil; and
controlling a flow control valve to control a flowrate of the circulating wash oil.

18. The method of claim 14, further comprising:
recycling at least a portion of the circulating wash oil to an entrance of a feed heater through a pump, wherein the cooling of the circulating wash oil occurs prior to passing the cooled circulating wash oil stream through the pump.

19. The method of claim 18, further comprising:
detecting a liquid level in the wash oil tank; and
controlling a flowrate of at least the portion of the circulating wash oil recycled to the inlet of the feed heater to control the level of the liquid in the wash oil tank.

20. The method of claim 14, further comprising:
removing a HVGO stream from the vacuum distillation unit during a distillation, wherein the wash oil stream comprises a portion of the HVGO stream that is recycled to the vacuum distillation unit during the distillation.
